(19) United States
(12) Patent Application Publication
(10) Pub. No.: US 2020/0412972 A1
(43) Pub. Date: Dec. 31, 2020

(54) SENSOR LOW POWER MODE TECHNIQUES

(71) Applicant: QUALCOMM Incorporated, San Diego, CA (US)

(72) Inventors: Ravi Shankar Kadambala, Hyderabad (IN); Soman Ganesh Nikhara, Hyderabad (IN); Bipineedu Chowdary Gummadi, Hyderabad (IN)

(21) Appl. No.: 16/454,618

(22) Filed: Jun. 27, 2019

(51) Int. Cl. H04N 5/232

(52) U.S. Cl. CPC H04N 5/232411; H04N 5/23245

(57) ABSTRACT

In multi-sensor devices (e.g., devices with multiple cameras, such as a dual camera device), it may be efficient to transition sensors from an active state or image capture state to a low power mode (LPM) to reduce device power consumption. When the multi-sensor device transitions from use of one sensor (e.g., a wide angle camera) to another sensor (e.g., a telescoping camera), the dual camera device may transition the sensor not being used to an LPM to reduce power consumption. As a sensor is transitioned out of the LPM (e.g., when the dual camera device zooms out of focus and intends to transition back to capturing a wide angle image), the sensor may load sensor setting configurations from in-sensor memory (e.g., flash memory) to reduce latency associated with initialization of sensor settings (e.g., to reduce latency associated with initialization of sensor settings from scratch or from default sensor settings).

### BACKGROUND

The following relates generally to image processing, and more specifically to sensor low power mode (LPM) techniques.

A device may include an optical instrument (e.g., a camera, an image sensor, etc.) for recording or capturing images, which may be stored locally, transmitted to another location, etc. For example, an image sensor may capture visual information using one or more photosensitive elements that may be tuned for sensitivity to a visible spectrum of electromagnetic radiation. Many electronic devices, such as smartphones, tablets, home security systems, automobiles, drones, aircrafts, etc. may use multiple cameras (e.g., multiple sensors) to capture images and video. In some examples, it may be inefficient in terms of device power consumption to power multiple cameras (e.g., when only a single camera or a subset of device cameras are being employed). As such, some devices may transition between cameras (e.g., a camera may be transitioned to an LPM while another camera of the device is in use).

In some cases, however, each of the multiple cameras may be initialized before use, for example, by determining one or more settings (e.g., an initial auto exposure setting, an initial white balance setting, etc.) for each camera and applying the determined settings to each of the multiple cameras. Such setting determination and camera initialization may be associated with undesirable latency (e.g., an amount of time between a camera being powered on and the camera being ready to capture images or video according to the determined settings).

### SUMMARY

The described techniques relate to improved methods, systems, devices, or apparatuses that support sensor low power mode (LPM) techniques. Generally, the described techniques provide for efficient transitioning of a sensor into an LPM and efficient transitioning of a sensor out of an LPM (e.g., efficient initialization of a sensor transitioning out of an LPM to an active image capture state). For example, a device (e.g., a dual camera device, a dual sensor device, etc.) may employ in-sensor flash memory to store sensor setting configurations before transitioning to a LPM. During sensor operation, such as initialization (e.g., initialization of sensor settings), when a sensor is transitioned from the LPM to an active state or an image capture state, the sensor may load sensor setting configuration information from the in-sensor flash memory, which may provide for faster and more efficient sensor initialization and decrease latency.

In multi-sensor devices (e.g., devices with multiple cameras, such as a dual camera device), it may be efficient to transition sensors from an active state or image capture state to an LPM to reduce device power consumption. For example, a dual camera device may employ a wide angle camera and a telescoping camera (e.g., a camera with a telephoto lens utilized for zoom operations). When the dual camera device transitions from use of the wide angle camera to the telescoping camera (e.g., when the dual camera device captures a wide angle image and intends to zoom to focus on an object), or vice versa, the dual camera device may transition the sensor not being used to an LPM to reduce power consumption. As a sensor is transitioned from (e.g., out of) the LPM (e.g., when the dual camera device zooms out of focus and intends to transition back to capturing a wide angle image), the sensor may load sensor setting configurations from in-sensor flash memory to reduce latency associated with configuration or initialization of sensor settings (e.g., to reduce latency associated with initialization of sensor settings from scratch or from default sensor settings).

A method of image processing at a device is described. The method may include determining to enable a first power mode for a first sensor, storing a sensor setting configuration in the first sensor based on determining to enable the first power mode for the first sensor, transitioning the first sensor from a second power mode to the first power mode that is a lower power mode than the second power mode, transitioning the first sensor from the first power mode to the second power mode, identifying an indication of the sensor setting configuration stored in the first sensor based on the transitioning from the first power mode to the second power mode, and initializing the first sensor based on the indication and the stored sensor setting configuration.

An apparatus for image processing at a device is described. The apparatus may include a processor, memory coupled with the processor, and instructions stored in the memory. The instructions may be executable by the processor to cause the apparatus to determine to enable a first power mode for a first sensor, store a sensor setting configuration in the first sensor based on determining to enable the first power mode for the first sensor, transition the first sensor from a second power mode to the first power mode that is a lower power mode than the second power mode, transition the first sensor from the first power mode to the second power mode, identify an indication of the sensor setting configuration stored in the first sensor based on the transitioning from the first power mode to the second power mode, and initialize the first sensor based on the indication and the stored sensor setting configuration.

Another apparatus for image processing at a device is described. The apparatus may include means for determining to enable a first power mode for a first sensor, storing a sensor setting configuration in the first sensor based on determining to enable the first power mode for the first sensor, transitioning the first sensor from a second power mode to the first power mode that is a lower power mode than the second power mode, transitioning the first sensor from the first power mode to the second power mode, identifying an indication of the sensor setting configuration stored in the first sensor based on the transitioning from the first power mode to the second power mode, and initializing the first sensor based on the indication and the stored sensor setting configuration.

A non-transitory computer-readable medium storing code for image processing at a device is described. The code may include instructions executable by a processor to determine to enable a first power mode for a first sensor, store a sensor setting configuration in the first sensor based on determining to enable the first power mode for the first sensor, transition the first sensor from a second power mode to the first power mode that is a lower power mode than the second power mode, transition the first sensor from the first power mode to the second power mode, identify an indication of the sensor setting configuration stored in the first sensor based on the transitioning from the first power mode to the second power mode, and initialize the first sensor based on the indication and the stored sensor setting configuration.

Some examples of the method, apparatuses, and non-transitory computer-readable medium described herein may further include operations, features, means, or instructions for determining to transition from the first sensor to a second sensor based on a capability of the first sensor, a capability of the second sensor, or both, where the determination to enable the first power mode for the first sensor may be based on the determination to transition from the first sensor to the second sensor.

Some examples of the method, apparatuses, and non-transitory computer-readable medium described herein may further include operations, features, means, or instructions for determining the sensor setting configuration based on a first scene lighting condition, where the sensor setting configuration includes an exposure setting, a brightness setting, a focus setting, a white balance setting, or some combination thereof. Some examples of the method, apparatuses, and non-transitory computer-readable medium described herein may further include operations, features, means, or instructions for adjusting the sensor setting configuration based on the initialized first sensor and a second scene lighting condition.

Some examples of the method, apparatuses, and non-transitory computer-readable medium described herein may further include operations, features, means, or instructions for setting a low power mode register command based on storing the sensor setting configuration, where the indication of the sensor setting configuration may be identified based on the set low power mode register command. In some examples of the method, apparatuses, and non-transitory computer-readable medium described herein, initializing the first sensor may include operations, features, means, or instructions for configuring the first sensor with the stored sensor setting configuration after identification of the indication.

In some examples of the method, apparatuses, and non-transitory computer-readable medium described herein, transitioning the first sensor from the second power mode to the first power mode may include operations, features, means, or instructions for transitioning the first sensor to a standby state, transitioning the first sensor to activate a reduced set of powered circuitry, powering off the first sensor, or some combination thereof, where the sensor setting configuration may be stored in the first sensor before transitioning the first sensor from the second power mode to the first power mode. In some examples of the method, apparatuses, and non-transitory computer-readable medium described herein, storing the sensor setting configuration in the first sensor may include operations, features, means, or instructions for storing, by a driver of the first sensor, the sensor setting configuration in flash memory of the first sensor.

Some examples of the method, apparatuses, and non-transitory computer-readable medium described herein may further include operations, features, means, or instructions for determining to enable the first power mode for the first sensor may be based on a low power mode register command received from a controller. Some examples of the method, apparatuses, and non-transitory computer-readable medium described herein may further include operations, features, means, or instructions for storing the sensor setting configuration may be based on the low power mode register command.

### BRIEF DESCRIPTION OF THE DRAWINGS

FIG. 1A illustrates an example of a system for image processing that supports sensor low power mode (LPM) techniques in accordance with aspects of the present disclosure.

FIG. 1B illustrates an example of a device architecture that supports sensor low power mode (LPM) techniques in accordance with aspects of the present disclosure.

FIG. 2 illustrates an example of a flowchart that supports sensor LPM techniques in accordance with aspects of the present disclosure.

FIG. 3 illustrates an example of a flowchart that supports sensor LPM techniques in accordance with aspects of the present disclosure.

FIGS. 4 and 5 show block diagrams of devices that support sensor LPM techniques in accordance with aspects of the present disclosure.

FIG. 5 shows a block diagram of a sensor configuration manager that supports sensor LPM techniques in accordance with aspects of the present disclosure.

FIG. 6 shows a diagram of a system including a device that supports sensor LPM techniques in accordance with aspects of the present disclosure.

FIGS. 7 and 8 show flowcharts illustrating methods that support sensor LPM techniques in accordance with aspects of the present disclosure.

### DETAILED DESCRIPTION

An image sensor may capture visual information using one or more photosensitive elements that may be tuned for a visible spectrum of electromagnetic radiation. An imaging device (e.g., an image sensor, camera, video recorder, mobile device, computer, etc.) may use a processor (e.g., an image signal processor (ISP)) to restore images from captured raw data. A processor may implement computation methods utilizing pixel information to reconstruct or restore images captured by a sensor of the device. In some cases, a device may include multiple sensors (e.g., multiple image sensors or multiple cameras, such as a dual camera device). For example, a device may employ a wide angle camera and a telescoping camera (e.g., a camera with a telephoto lens utilized for zoom operations). A wide angle camera (e.g., 1× zoom) may be used to capture wide angle images and a telescoping camera (e.g., 1.5× zoom, 2× zoom, 4× zoom, etc.) may be used to capture images of focused objects (e.g., via adjustment of a lens for focusing at various zoom levels).

In some cases, when a device transitions from use of one sensor to another (e.g., from a wide angle camera to a telescoping camera, from a telescoping camera to a wide angle camera), the device may transition some sensors, such as those not being used, to a low power mode (LPM) to reduce power consumption by one or more unused sensors, and to reduce power consumption by the device as a whole. Accordingly, as the device utilizes different sensors for different applications (e.g., as a device transitions from using a wide angle camera to a telescoping camera to focus or zoom in on an object, as a device transitions from using a telescoping camera to a wide angle camera to zoom out to capture a wide angle image, etc.) sensors may be transitioned in to an LPM for power savings, and out of the LPM for active image capture operations.

Generally, upon powering of a sensor (e.g., upon turning on a device or a sensor, upon transitioning a sensor from an LPM to an active image capture state, etc.), the sensor may initialize sensor settings in order to effectively perform image capture operations. For example, a sensor may initialize or set sensor settings such as exposure settings, brightness settings, focus settings, white balance settings, etc. such that the sensor may effectively (e.g., clearly, accurately, visibly, etc.) capture images in a given scene or scenario under various lighting conditions. In some cases, such sensor setting initialization procedures may be associated with undesirable latency and power consumption (e.g., as a sensor may be powered on well in advance of usage in order to initialize settings in time for sensor usage). For example, sensor initialization procedures may include a sensor identifying some settings, such as default initial settings, from device memory, and the sensor may tune settings according to lighting conditions, device zoom settings, sensor hardware, etc. It may be desirable to reduce the latencies associated with such sensor initialization procedures, for example, to increase the speed with which a camera may be ready to capture images or video, to reduce device power consumption associated with initialization procedures, etc.

According to the described techniques, a device (e.g., a dual camera device) may efficiently transition one or more sensors (e.g., cameras) in and out of one or more LPMs. For example, a device (e.g., a dual camera device, a dual sensor device, etc.) may employ in-sensor flash memory to store sensor setting configurations before transitioning a sensor to a LPM. As such, a sensor that has previously tuned or calibrated some sensor settings (e.g., according to current or recent image capture operations, according to current or recently observed lighting conditions, according to sensor-specific hardware or device image capture commands, etc.) may store such settings (e.g., a sensor setting configuration) in flash memory of the sensor (e.g., before the sensor transitioning into a LPM). During sensor initialization (e.g., initialization of sensor settings) when a sensor is transitioned from an LPM to an active state or an image capture state, the sensor may load sensor setting configuration information from the in-sensor flash memory, which may provide for faster and more efficient sensor initialization. For example, a sensor may load sensor setting configuration information from in-sensor flash memory faster than default setting information that may otherwise be stored in the memory of the device. Further, calibrating or tuning sensor settings from such a stored sensor setting configuration may reduce sensor initialization time compared to calibrating or tuning sensor settings from default settings (e.g., as the stored sensor setting configuration may more closely resemble ultimately established sensor settings compared to default or other base line settings).

Aspects of the disclosure are initially described in the context of an image capture system. Example devices and flowcharts for implementing the described techniques are then discussed. Aspects of the disclosure are further illustrated by and described with reference to apparatus diagrams, system diagrams, and flowcharts that relate to sensor LPM techniques

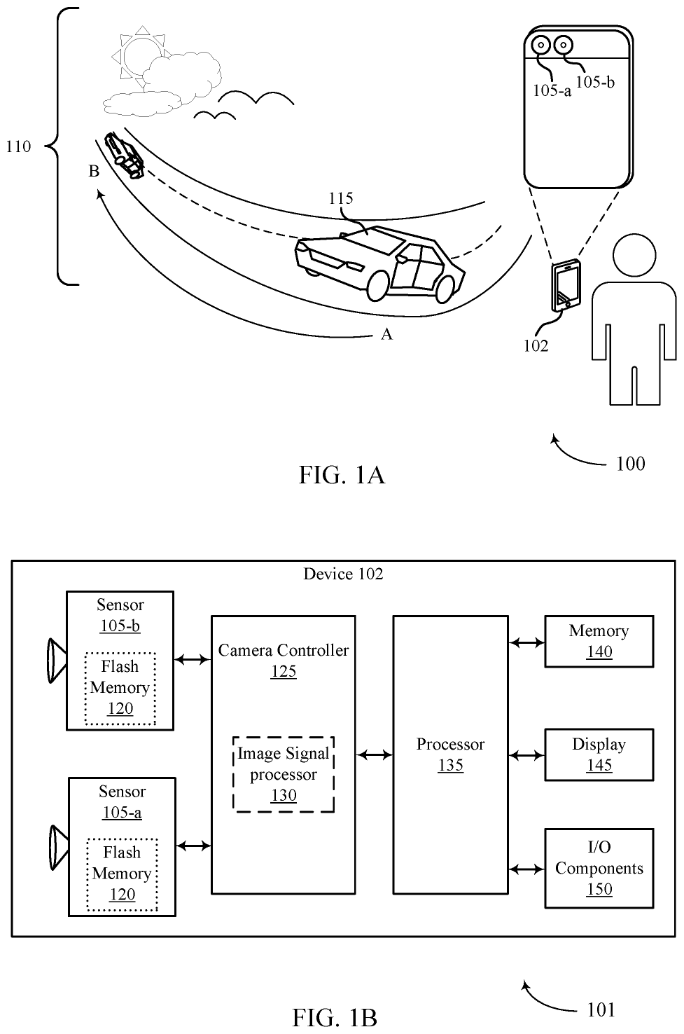

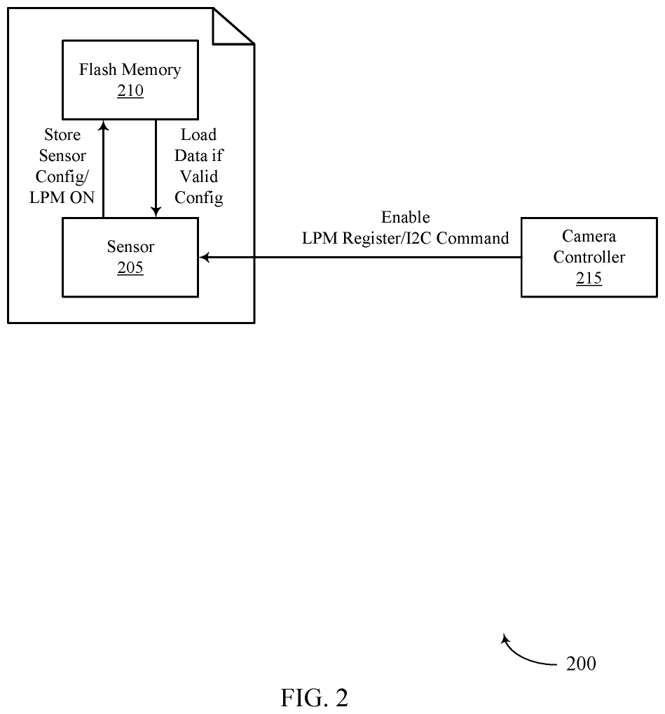

FIG. 1A illustrates an example of a system 100 (e.g., an image capture system, a dual camera imaging system, etc.) that supports sensor LPM techniques in accordance with aspects of the present disclosure. System 100 may include a device 102 that includes sensor 105-a and sensor 105-b. System 100 may further include a user of the device 102 capturing an image of some scene 110 using sensor 105-a and/or sensor 105-b of the device 102. A device 102 may utilize sensor 105-a and sensor 105-b, according to techniques described herein, to capture an image, a sequence of images, a video stream, etc. of an object 115 and/or scene 110. For example, as an object 115 moves from Point A to Point B, a device may transition from using a first sensor (e.g., sensor 105-a) to using a second sensor (e.g., sensor 105-b) to capture the image (e.g., as sensor 105-a and sensor 105-b may be utilized for different zoom levels).

Techniques for sensor LPM (e.g., efficient techniques for a device 102 to transition sensors 105 in and out of a LPM) are described herein. For example, a device 102 may employ a sensor 105-a (e.g., a wide angle camera) and a sensor 105-b (e.g., a telescoping camera with lens utilized for zoom operations). When the device 102 transitions from use of the sensor 105-a to the sensor 105-b (e.g., when the device 102 captures a wide angle image and intends to zoom to focus on an object), or vice versa, the device 102 may transition the sensor 105 that is not being used to an LPM to reduce power consumption. As a sensor 105 is transitioned out of the LPM (e.g., when the dual camera device zooms out of focus and intends to transition back to capturing a wide angle image), the sensor 105 may load sensor setting configurations from in-sensor flash memory to reduce latency associated with initialization of sensor settings (e.g., to reduce latency associated with initialization of sensor settings from scratch or from default sensor settings).

For example, device 102 may capture images (e.g., an image, a sequence of images, a video stream, etc.) using sensor 105-a. When an object 115 moves from Point A to Point B, the device 102 may wish to zoom in on the object 115 as it moves into the distance. As such, device 102 may transition from using sensor 105-a (e.g., a wide angle camera) to sensor 105-b (e.g., a telescoping camera). If sensor 105-b is used, for example, for 1.5× zoom and beyond (e.g., for 1.5× zoom to 2× zoom, 4× zoom etc.), the device 102 may use the sensor 105-a to zoom to 1.5×, upon which the device 102 may transition to using sensor 105-b for further zooming. In such an example, sensor 105-b may be transitioned out of an LPM when, for example, the sensor 105-a reaches 1.2× zoom, as the sensor 105-b may take time (e.g., the time the sensor 105-a takes to zoom from 1.2× to the 1.5×) to initialize sensor settings such that an approximately seamless transition may be made from the sensor 105-a to the sensor 105-b. That is, the device may transition the sensor 105-b out of an LPM at a time accounting for initialization latency of the sensor 105-b, such that once the sensor 105-a reaches a threshold zoom (e.g., 1.5×) the sensor 105-b may be initialized and prepared to take over image capture operations for additional zooming (e.g., to 2× zoom, 4× zoom, etc.). According to the techniques described herein, such initialization times (e.g., time durations associated with initialization of sensor 105-b) may be reduced, which may result in increased power savings (e.g., as the sensor 105-b may remain in the LPM longer before transitioning to an active image capture state). Such techniques may also be applied when the device 102 transitions from using sensor 105-b back to sensor 105-a (e.g., when device 102 goes from a zoom image capture back to wide angle image capture).

Techniques described with reference to aspects of system 100 are done so for exemplary purposes only, and are not intended to be limiting in terms of the applicability of the described techniques. That is, the techniques described may be implemented in, or applicable to, other imaging examples (e.g., other examples of image sensor or camera based applications, such as security systems, drone imaging, etc.), without departing from the scope of the present disclosure. For example, the techniques described may generally provide for efficient sensor LPM techniques, efficient sensor initialization techniques, etc. by utilizing in-sensor flash memory to store sensor setting configurations such that when a sensor 105 exits an LPM the sensor 105 may more rapidly tune or calibrate to appropriate sensor settings for image capture operations.

As used herein, a device 102 may refer to any device with a camera, image sensor, light sensor, etc. In some cases, device 102 may refer to a camera, a mobile device, a wireless device, a remote device, a handheld device, a subscriber device, a personal electronic device such as a cellular phone, a personal digital assistant (PDA), a tablet computer, a laptop computer, a personal computer, or some other suitable terminology. Further examples of devices 102 that may implement one or more aspects of sensor LPM techniques may include camcorders, webcams, computer monitors, cockpit controls and/or displays, camera view displays (such as the display of a rear-view camera in a vehicle), etc. The term “device” is not limited to one or a specific number of physical objects (such as one smartphone). As used herein, a device 102 may be any electronic device with multiple parts that may implement at least some portions of this disclosure. For one example, a device 102 may be a video security system including one or more hubs and two or more separate cameras. As another example, a device 102 may be a smartphone including two cameras such as sensors 105-a and sensor 105-b. While the described techniques and examples use the term “device” to describe various aspects of this disclosure, the term “device” is not limited to a specific sensor or hardware configuration, type, or number of objects.

Any of such devices may include at least one light sensor (e.g., sensor 105) that outputs a signal, or information bits, indicative of light (e.g., reflective light characteristics of scene 110 (e.g., which may include a target object 115), light emitted from scene 110, an amount or intensity of light associated with scene 110, red green blue (RGB) values associated with scene 110, etc.). For example, a sensor 105 may include a lens (e.g., to capture or focus incoming light), a color filter array (CFA) (e.g., to filter the incoming light according to different individual filter elements of the CFA), a pixel sensor array (e.g., to detect or measure the filtered light), and/or other hardware or components for capturing such light or image information. The sensor 105 may then signal or pass information collected to other components of the device 102 (e.g., a camera controller 125, a processor 135, etc. In some aspects, one of the cameras (such as sensor 105-a) may be a primary camera, and the other camera (such as sensor 105-b) may be an auxiliary camera. Additionally or alternatively, the sensor 105-b may have a different focal length, capture rate, resolution, color palette (such as color versus black and white), and/or field of view or capture than the sensor 105-a. While described herein with respect to a device including two cameras, aspects of the present disclosure are applicable to any number of cameras and camera configurations, and are therefore not limited to two cameras (such as a dual camera device).

In some cases, sensor 105 may refer to a complementary metal oxide semiconductor (CMOS) image sensor, a charge-coupled device (CCD), etc. used in digital imaging applications to capture images (e.g., scenes 110, target objects 115 within some scene 110, etc.). In some examples, a sensor 105 may include an array of sensors (e.g., a pixel sensor array). Each sensor in the pixel sensor array may include at least one photosensitive element for outputting a signal having a magnitude proportional to the intensity of incident light or radiation contacting the photosensitive element. When exposed to incident light reflected or emitted from a scene 110 (e.g., or target object 115 within some scene 110), each sensor in the pixel sensor array may output a signal having a magnitude corresponding to an intensity of light at one point in the scene 110 (e.g., at an image capture time). The signals output from each photosensitive element may be processed (e.g., by the camera controller 125 and/or processor 135) to form an image representing the captured scene. In general, a pixel brightness measurement or a pixel value from an sensor 105 (e.g., from pixel sensor array) may correspond to a pixel intensity value, RGB values of a pixel, infrared values of a pixel, or any other parameter associated with light (e.g., or the image being captured, the picture being taken, etc.). As an example, a pixel sensor array may include one or more photosensitive elements for measuring such information. In some examples, the photosensitive elements may have a sensitivity to a spectrum of electromagnetic radiation (e.g., including the visible spectrum of electromagnetic radiation, infrared spectrum of electromagnetic radiation, etc.). For example, the at least one photosensitive element may be tuned for sensitivity to a visible spectrum of electromagnetic radiation (e.g., by way of depth of a photodiode depletion region associated with the photosensitive element).

FIG. 1B illustrates an example of a device architecture 101 that supports sensor LPM techniques in accordance with aspects of the present disclosure. For example device architecture 101 may illustrate an example architecture of a device 102. As discussed, a device 102 may include sensor 105-a and sensor 105-b. Sensor 105-a and sensor 105-b may each include in-sensor flash memory 120. Further, sensor 105-a and sensor 105-b may be in electronic communication with an camera controller 125 and a processor 135 (e.g., some image signal processor and/or image signal processing software). In some cases, sensor 105-a and sensor 105-b may be in electronic communication with an camera controller 125, and the camera controller 125 may be in electronic communication with a processor 135. In some examples, the camera controller 125 and the processor 135 may be implemented on a single substrate or system on chip (SoC), or may be separately located.

Device 102 may be any suitable device capable of capturing images or video including, for example, wired and wireless communication devices (such as camera phones, smartphones, tablets, security systems, dash cameras, laptop computers, desktop computers, automobiles, drones, aircraft, and so on), digital cameras (including still cameras, video cameras, and so on), or any other suitable device. The example device 102 is shown in to include a first sensor 105-a, a second sensor 105-b, a processor 135, a memory 140, a camera controller 125 (e.g., which may include an image signal processor 130, or in some cases the processor 135 and/or camera controller 125 may perform image signal processing operations), a display 145, and a number of input/output (I/O) components 150. The device 102 may include additional features or components not shown. For example, a wireless interface, which may include a number of transceivers and a baseband processor, may be included for a wireless communication device. In some cases, device 102 may include additional sensors or cameras other than senor 105-a and sensor 105-b. The disclosure should not be limited to any specific examples or illustrations, including example device 102.

As discussed herein, a sensor 105 may generally refer to a camera, an image sensor, a light sensor, other sensors, or the like. For example, a sensor 105 may include a lens, a color filter array, a pixel sensor array, and/or other hardware which may collect (e.g., focus), filter, and detect lighting information. The lighting information may be passed to a camera controller 125 (e.g., for processing and reconstruction of the raw image data by an image signal processor 130). The image signal processor 130 (e.g., one or more driver circuits for performing image processing operations) may then process the information collected by the sensor 105 (e.g., to reconstruct or restore the captured image of scene 110). In some examples, the processed image information (e.g., determined or output from the camera controller 125, image signal processor 130, and/or processor 135) may then be passed to a display 145 of the device. In other examples, the processed image information may be stored by the device, passed to another device, etc. The camera controller 125 may include one or more driver circuits for controlling sensor 105-a and/or sensor 105-b (e.g., driver circuits for transitioning sensor 105-a and/or sensor 105-b in and out of a LPM).

The sensor 105-a and sensor 105-b may be capable of capturing individual image frames (such as still images) and/or capturing video (such as a succession of captured image frames). In some cases, the sensor 105-a and sensor 105-b also may themselves include one or more image sensors or pixel arrays (not shown for simplicity) and shutters for capturing an image frame and providing the captured image frame to the camera controller 125. The memory 140 may be a non-transient or non-transitory computer readable medium storing computer executable instructions to perform all or a portion of one or more operations described in this disclosure. In some cases, the device 102 may also include a power supply, which may be coupled to or integrated into the device 102.

The processor 135 may be one or more suitable processors capable of executing scripts or instructions of one or more software programs (such as instructions) stored within memory 140. In some aspects, the processor 135 may be one or more general purpose processors that execute instructions to cause the device 102 to perform any number of functions or operations. In additional or alternative aspects, the processor 135 may include integrated circuits or other hardware to perform functions or operations without the use of software. While shown to be coupled to each other via the processor 135 in the example of FIG. 1, the processor 135, memory 140, camera controller 125, the display 145, and I/O components 150 may be coupled to one another in various arrangements. For example, the processor 135, memory 140, camera controller 125, the display 145, and/or I/O components 150 may be coupled to each other via one or more local buses (not shown for simplicity).

The display 145 may be any suitable display or screen allowing for user interaction and/or to present items (such as captured images and video) for viewing by a user. In some aspects, the display 145 may be a touch-sensitive display. The I/O components 150 may be or may include any suitable mechanism, interface, or device to receive input (such as commands) from the user and to provide output to the user. For example, the I/O components 150 may include (but are not limited to) a graphical user interface, keyboard, mouse, microphone and speakers, and so on.

The camera controller 125 may include an image signal processor 130, which may be one or more image signal processors to process captured image frames or video provided by the sensor 105-a and/or the sensor 105-b. In some example implementations, the camera controller 125 (such as image signal processor 130) may control operation of the sensor 105-a and the sensor 105-b. In some aspects, the image signal processor 130 may execute instructions from a memory (such as instructions from memory 140 or instructions stored in a separate memory coupled to the image signal processor 130) to control operation of the sensor 105-a and the sensor 105-b. In other aspects, the camera controller 125 may include specific hardware to control operation of the sensor 105-a and the sensor 105-b. The camera controller 125 and/or image signal processor 130 may alternatively or additionally include a combination of specific hardware and the ability to execute software instructions.

Before capturing image frames or video, a sensor 105 may be initialized to determine initial capture settings for the sensor 105. Irrespective of the number of sensors 105 that are used or are initialized (such as a device with a single camera, a device with a dual camera, and so on), the initial capture settings for the sensor 105 may be determined based on the sensor 105's own image captures (e.g., based on images captured by the sensor 105 after transitioning out of a LPM). Example sensor settings (e.g., which may be referred to as capture settings) may include an automatic exposure setting, an automatic white balance setting, an initial focal length setting, whether to use flash, a frame rate, and so on.

For example, in some cases, when a sensor 105 is initialized, the sensor 105 is powered on, and initial frames captured by the sensor 105 at the default sensor settings (e.g., which may be stored in memory 140 or in camera controller 125) are used to determine the initial sensor settings. For devices that include a user display, the user display may not show previews during initialization of the sensor 105 to provide a better user experience (such as image captures not being shown until the captures are acceptable to an average person's perception). Instead, the initial sensor settings are determined (e.g., calibrated from baseline default settings based on initial images captured by the sensor 105), and initialization of the sensor 105 typically completes before the display previews any images captured by the sensor 105. As such, the initialization of the sensor 105, relying on default settings, may take a significant amount of time, which can reduce the user experience and/or cause delays in capturing images by the camera.

According to the techniques described herein, devices (e.g., device 102) may employ in-sensor flash memory 120 to store sensor setting information (e.g., sensor setting configurations), such that when a sensor 105 is initialized (e.g., when a sensor is transitioned from an LPM to an active state or an image capture state) the sensor 105 may load or retrieve the sensor setting configuration information from in-sensor flash memory 120 and begin initialization or calibration (e.g., based on captured images) starting from the stored sensor setting configuration. In some examples, flash memory 120 may be interchangeable with other types of in-sensor memory. For instance, in some cases, flash memory 120 may be replaced by other non-volatile memory (e.g., electrically erasable programmable read-only memory (EEPROM)), other volatile memory (e.g., ferroelectric random-access memory (FeRAM), dynamic random-access memory (DRAM)), other memory, etc.

Power savings may be essential to commercialization of multi-camera systems on power sensitive platforms (e.g., mobile phones). LPMs may saves power on the inactive (auxiliary) cameras (e.g., sensor 105-b) when possible by powering down unneeded hardware. The auxiliary cameras may refer to cameras or sensors not currently shown on a camera preview. It may not always be appropriate to put the auxiliary cameras into LPM, but the software may aggressively utilize LPM when applicable for power savings. There may be different LPM options depending on what is needed by the system and supported by the hardware. Alternative approaches in LPM may include camera interface (CAMIF) Frame Drop (e.g., auxiliary CAMIF(before ISP) may drop all frames coming from the sensor, but the sensor may still be streaming at full frames per second (FPS)), CAMIF Frame Skip (e.g., auxiliary CAMIF may skip frames at regular intervals, and the sensor runs at full FPS), Disable hardware synchronization (HW-Sync) and Reduce the auxiliary sensor Frame rate (e.g., disable sync in ISP/3A/PPROC blocks and/or disable sensor HW-sync (sensor dependent) which may allow reducing auxiliary sensor frame-rate), and Sensor Sleep/Power off (e.g., auxiliary sensor may be placed in LPM (software stand-by or Power off the sensor) and waked from LPM mode (power on the sensor and reconfigure the sensor)).

Improved power savings may be realized when a sensor is completely shut down. When a sensor 105 is powered off and powered on, the sensor 105 may goes into a state (e.g., a LPM) where the sensor 105 has to be reinitialized and reconfigured to some sensor mode again (e.g., an active state or an image capture state). In some cases, such may be associated with some latency (e.g., some 200-300 milliseconds, depending on sensor manufacturer and their initialization settings) to power on and reconfigure the sensor 105.

The techniques described herein provide for more efficient LPM operation and sensor initialization. In some examples, a register (e.g., through Inter-Integrated Circuit (I2C)) may be programmed in the sensor 105 when the LPM mode is enabled by the camera controller 125. Whenever the register is set, flash memory 120 (e.g., or EEPROM memory) may store the sensor setting configurations (e.g., mode settings/exposure settings, etc.) before the sensor 105 turns off (e.g., before the sensor 105 transitioning to an LPM mode), and the sensor 105 or camera controller 125 may enable an LPM ENABLED BIT in the flash memory 120. Once the sensor 105 is again powered on, the sensor 105 may check the LPM ENABLED BIT in flash memory 120 and, if the flash memory 120 has any valid configuration as indicated by the LPM ENABLED BIT in the register, the sensor 105 may start in the configuration stored in the flash memory 120 (e.g., instead of using default settings). In some cases, sensor 105-a and sensor 105-b may be implemented on a single piece of hardware or may be connected to a single SoC, and may share flash memory 120.

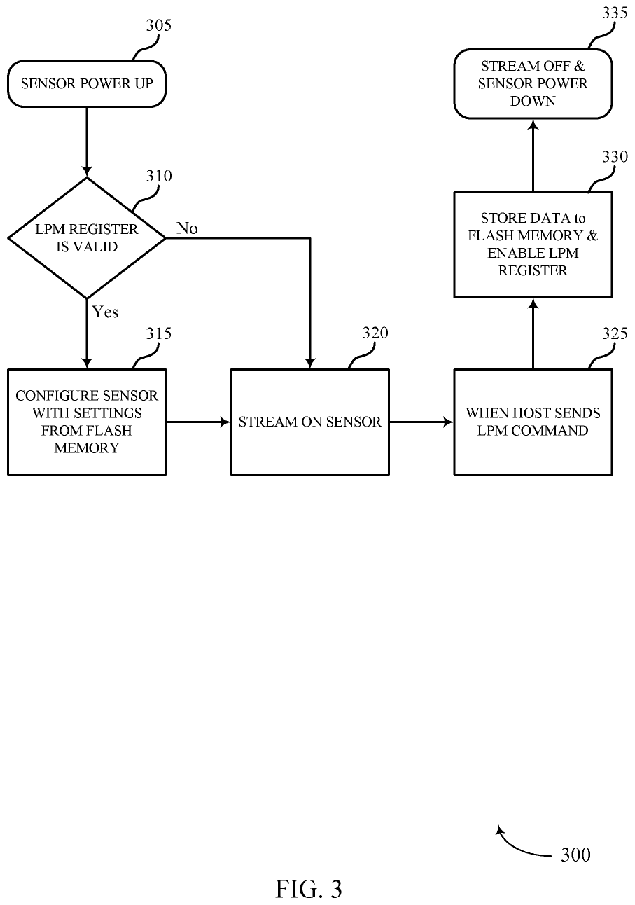

FIG. 2 illustrates an example of a flowchart 200 that supports sensor LPM techniques in accordance with aspects of the present disclosure. In some examples, flowchart 200 may implement aspects of system 100 or aspects of flowchart 200 may be implemented via aspects of device architecture 101. For example, flowchart 200 may illustrate a camera controller 215 (e.g., which may be an example of a camera controller 125) and a sensor 205 (e.g., which may be an example of a sensor 105) implementing efficient LPM transition and sensor initialization techniques described herein.

A camera controller 215 may send commands to a sensor 205, for example, to transition the sensor 205 to a LPM, to transition the sensor 205 out of an LPM (e.g., to transition the sensor 205 to an active state or image capture state), etc. For example, the camera controller 215 may send (e.g., pass) I2C commands to control sensor 205 operations and behavior. An enable LPM register command (e.g., an enable LPM register/I2C command) may control or configure the sensor 205 to enable or set a register bit (e.g., an LPM ENABLED BIT) and transition to a LPM. The indication sent by the camera controller 215 to the sensor 205 may be sent as one or more information bits indicating the register bit is to be set, that the sensor 205 is to store sensor setting configuration information in flash memory 210, that the sensor is to transition to a LPM, or some combination thereof. That is, an enable LPM register/I2C command may explicitly and/or implicitly configure the sensor 205 to enable the LPM register bit, a store sensor setting configuration, and enter an LPM mode (e.g., in some cases an enable LPM register/I2C command may indicate that the sensor 205 is to transition to a LPM, which may implicitly configure the sensor 205 to enable the LPM register, store sensor setting configuration information, and transition to the LPM. Upon receiving an enable LPM register/I2C command, the sensor 205 may store sensor setting configuration information in flash memory 210 and enable the LPM register (e.g., and enter the LPM).

In some cases, a sensor driver may program the sensor setting configuration information into the flash memory 210 upon receiving such an enable LPM register/I2C command. As discussed, the sensor 205 may also enable an LPM bit register in such scenarios. The flash memory 210 may store the sensor setting configuration of the sensor 205 before the sensor enters the LPM (e.g., before the sensor 205 powers down at least a portion of sensor 205 circuitry). In some cases, default settings configured by the device may suffice, and the camera controller 215 may not command the sensor 205 to set the LPM register (e.g., in which case the sensor 205 may initialize with default settings upon a transition out of the LPM). In some examples, flash memory 210 may be interchangeable with other types of in-sensor memory. For instance, in some cases, flash memory 210 may be replaced by other non-volatile memory (e.g., electrically erasable programmable read-only memory (EEPROM)), other volatile memory (e.g., ferroelectric random-access memory (FeRAM), dynamic random-access memory (DRAM)), other memory, etc.

Camera controller 215 may further send commands (e.g., I2C commands) to sensor 205 to transition the sensor from the LPM to an active state or image capture state. In such cases, the sensor 205 may load sensor setting configuration information from flash memory 210 if the LPM ENABLE BIT is set indicating that flash memory 210 has a valid sensor setting configuration for sensor 205 initialization. In cases where the sensor 205 receives a command to transition the sensor from the LPM to an active state or image capture state and an enable LPM register command was not previously received from the camera controller 215, the sensor 205 may check the LPM register bit, identify that the LPM register is not enabled (e.g., that flash memory 210 does not include a valid sensor setting configuration), and initialize based on some default sensor settings.

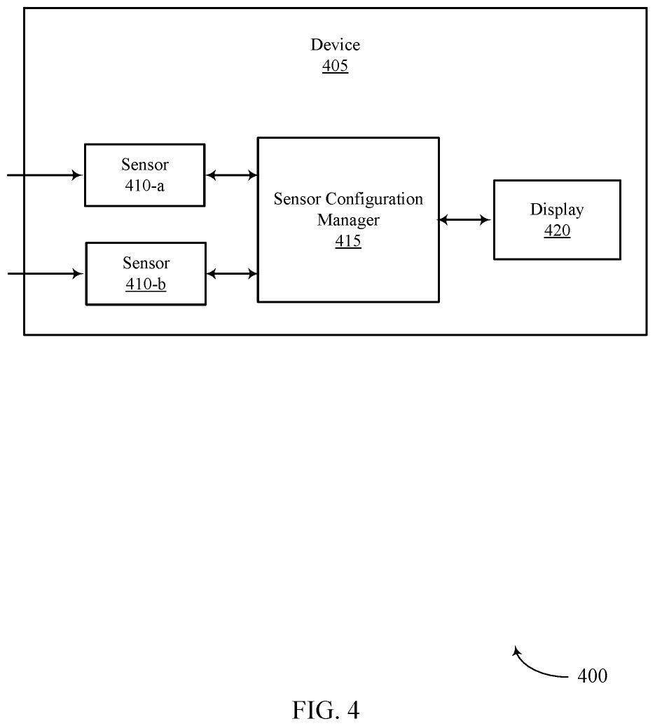

FIG. 3 illustrates an example of a flowchart 300 that supports sensor LPM techniques in accordance with aspects of the present disclosure. In some examples, flowchart 300 may be implemented by aspects of system 100 or aspects of flowchart 300 may be implemented by aspects of device architecture 101. For example, flowchart 300 may illustrate a process flow of a sensor of a device (e.g., a device 102, such as a multi-sensor device, a dual camera device, etc.) implementing efficient LPM transition and sensor initialization techniques described herein.

At 305, a sensor may power up (e.g., a camera controller may send an I2C command or other command to a sensor to transition the sensor from an LPM to an active state or an image capture state). At 310, the sensor may check whether the LPM register is valid (e.g., whether the LPM ENABLE BIT has been set by the sensor before the sensor previously entering the LPM). If the LPM register is valid, the sensor may initialize with settings stored in flash memory, and may begin streaming at 320 (e.g., may begin one or more image capture operations). If the LPM register is not valid or if the LPM register was not previously set, the sensor may proceed to 320 (e.g., initializing using default settings).

At 325, a host (e.g., a camera controller) may send an LPM command (e.g., an enable LPM register/I2C command) to the sensor. At 330, the sensor may store data (e.g., sensor setting configuration information) to a memory, which may be a flash memory in some examples, and enable the LPM register based on the command received at 325. At 335, the sensor may turn the streaming off (e.g., cease image capture operations) and power down to enter the LPM.

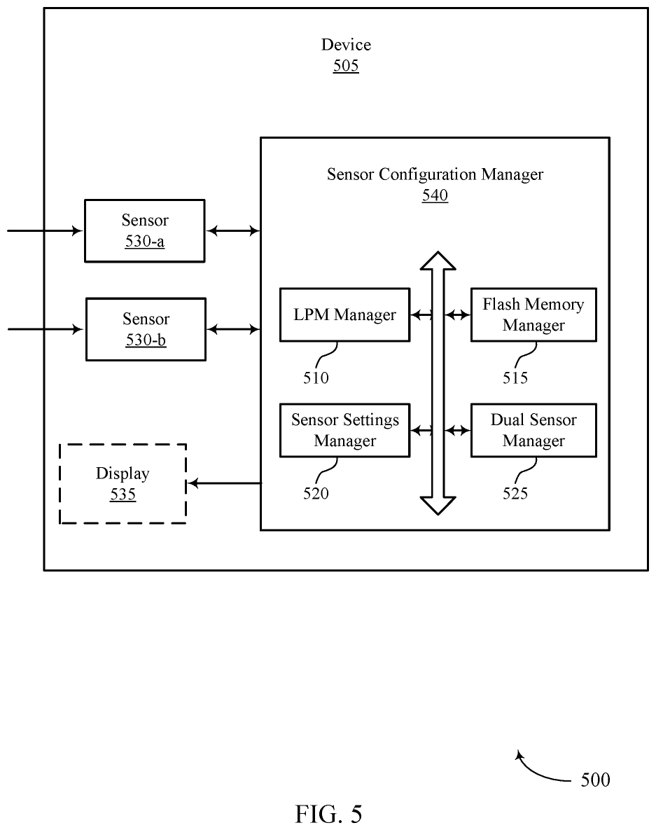

FIG. 4 shows a block diagram 400 of a device 405 that supports sensor LPM techniques in accordance with aspects of the present disclosure. The device 405 may be an example of aspects of a device as described herein. The device 405 may include one or more sensors 410, a sensor configuration manager 415, and a display 420. The device 405 may also include a processor. Each of these components may be in communication with one another (e.g., via one or more buses).

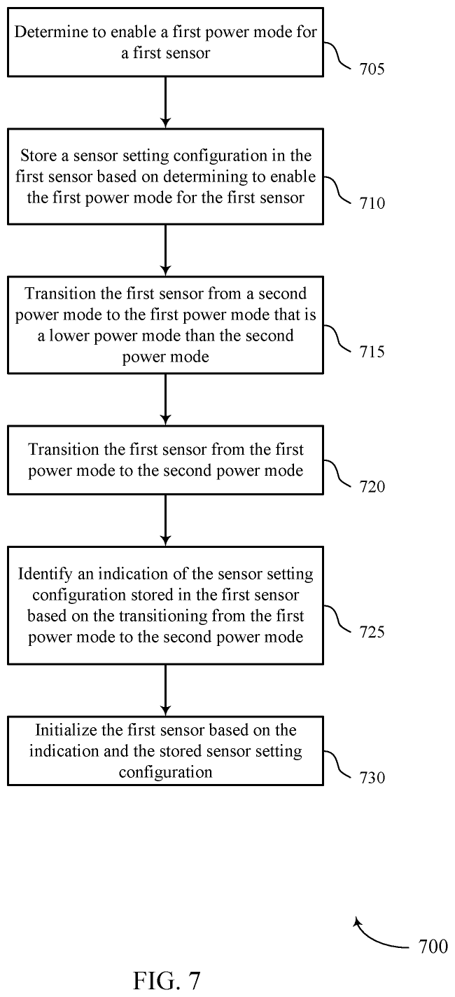

The one or more sensors 410 (e.g., image sensors, cameras, etc.) may receive information (e.g., light), which may be passed on to other components of the device 405. In some cases, the sensors 410 may be an example of aspects of the I/O controller 615 described with reference to FIG. 6. As discussed above, the sensor 410 may utilize one or more photosensitive elements that have a sensitivity to a spectrum of electromagnetic radiation to receive information (e.g., to receive a pixel intensity value, RGB values of a pixel, etc.). The information may then be passed on to other components of the device 405.

The sensor configuration manager 415 may determine to enable a first power mode (e.g., a LPM) for a first sensor (e.g., sensor 410-a), transition the first sensor from a second power mode (e.g., a higher power mode, such as an active state or image capture state) to the first power mode that is a lower power mode than the second power mode. The sensor configuration manager 415 may transition the first sensor from the first power mode to the second power mode, store a sensor setting configuration in the first sensor based on determining to enable the first power mode for the first sensor. The sensor configuration manager 415 may identify an indication of the sensor setting configuration stored in the first sensor based on the transitioning from the first power mode to the second power mode, and initialize the first sensor based on the indication and the stored sensor setting configuration. The sensor configuration manager 415 may be an example of aspects of the sensor configuration manager 610 described herein.

The sensor configuration manager 415, or its sub-components, may be implemented in hardware, code (e.g., software or firmware) executed by a processor, or any combination thereof. If implemented in code executed by a processor, the functions of the sensor configuration manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The sensor configuration manager 415, or its sub-components, may be physically located at various positions, including being distributed such that portions of functions are implemented at different physical locations by one or more physical components. In some examples, the sensor configuration manager 415, or its sub-components, may be a separate and distinct component in accordance with various aspects of the present disclosure. In some examples, the sensor configuration manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The display 420 may be any suitable display or screen allowing for user interaction and/or to present items (such as captured images and video) for viewing by a user. In some aspects, the display 420 may be a touch-sensitive display. In some cases, the display 420 may display images captured by sensor 410-a and sensor 410-b, where the displayed images that are captured by either sensor 410-a and sensor 410-b may depend on the configuration of sensor 410-a and sensor 410-b by the sensor configuration manager 415.

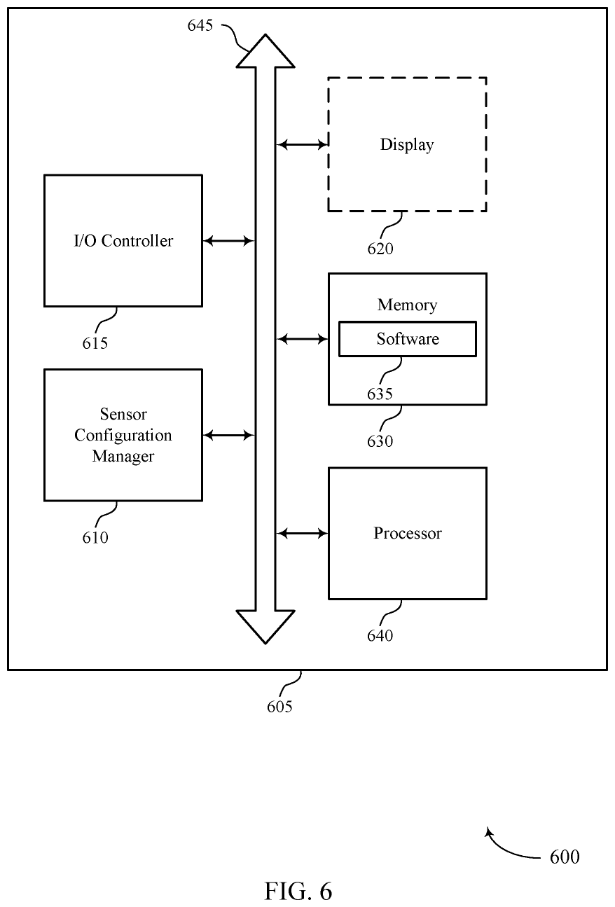

FIG. 5 shows a block diagram 500 of a device 505 that supports sensor LPM techniques in accordance with aspects of the present disclosure. The device 505 may be an example of aspects of a device 405 or a device 102 as described herein. The device 505 may include a one or more sensors 530, a sensor configuration manager 540, and a display 535. The sensor configuration manager 540 may be an example of aspects of a sensor configuration manager 415, or a sensor configuration manager 610 described herein. The sensor configuration manager 540 may include an LPM manager 510, a flash memory manager 515, a sensor settings manager 520, and a dual sensor manager 525. The device 505 may also include a processor. Each of these modules may communicate, directly or indirectly, with one another (e.g., via one or more buses).

The one or more sensors 530 (e.g., image sensors, cameras, etc.) may receive information (e.g., light), which may be passed on to other components of the device 505. In some cases, the sensors 530 may be an example of aspects of the I/O controller 615 described with reference to FIG. 6. As discussed above, the sensor 530 may utilize one or more photosensitive elements that have a sensitivity to a spectrum of electromagnetic radiation to receive information (e.g., to receive a pixel intensity value, RGB values of a pixel, etc.). The information may then be passed on to other components of the device 505.

The LPM manager 510 may determine to enable a first power mode (e.g., a LPM) for a first sensor (e.g., a sensor 530-a). In some cases, the means for determining to enable a first power mode for a first sensor may refer to the LPM manager 510 (e.g., or the LPM manager 510 in electric communication with a processor). In some examples, the LPM manager 510 may transition the first sensor from a second power mode to the first power mode that is a lower power mode than the second power mode. In some cases, the means for transitioning the first sensor from a second power mode to the first power mode that is a lower power mode than the second power mode may refer to the LPM manager 510 (e.g., or the LPM manager 510 in electric communication with a processor). In some examples, the LPM manager 510 may transition the first sensor from the first power mode to the second power mode. In some cases, the means for transitioning the first sensor from the first power mode to the second power mode may refer to the LPM manager 510 (e.g., or the LPM manager 510 in electric communication with a processor).

In some examples, the LPM manager 510 may set a low power mode register command based on storing the sensor setting configuration, where the indication of the sensor setting configuration is identified based on the set low power mode register command. In some examples, the LPM manager 510 may transition the first sensor to a standby state, transitioning the first sensor to activate a reduced set of powered circuitry, powering off the first sensor, or some combination thereof, where the sensor setting configuration is stored in the first sensor before transitioning the first sensor from the second power mode to the first power mode. In some examples, the LPM manager 510 may determine to enable the first power mode for the first sensor is based on a low power mode register command received from a controller.

The flash memory manager 515 may store a sensor setting configuration in the first sensor based on determining to enable the first power mode for the first sensor. In some cases, the means for storing a sensor setting configuration in the first sensor based at least in part on determining to enable the first power mode for the first sensor may refer to the flash memory manager 515 (e.g., or the flash memory manager 515 in electric communication with a processor). In some examples, the flash memory manager 515 may identify an indication of the sensor setting configuration stored in the first sensor based on the transitioning from the first power mode to the second power mode. In some cases, the means for identifying an indication of the sensor setting configuration stored in the first sensor based at least in part on the transitioning from the first power mode to the second power mode may refer to the flash memory manager 515 (e.g., or the flash memory manager 515 in electric communication with a processor). In some examples, the flash memory manager 515 may store, by a driver of the first sensor, the sensor setting configuration in flash memory of the first sensor. In some examples, the flash memory manager 515 may store the sensor setting configuration is based on the low power mode register command. In some examples, flash memory 515 may be interchangeable with other types of in-sensor memory. For instance, in some cases, flash memory 515 may be replaced by other non-volatile memory (e.g., electrically erasable programmable read-only memory (EEPROM)), other volatile memory (e.g., ferroelectric random-access memory (FeRAM), dynamic random-access memory (DRAM)), other memory, etc.

The sensor settings manager 520 may initialize the first sensor based on the indication and the stored sensor setting configuration. In some cases, the means for initializing the first sensor based at least in part on the indication and the stored sensor setting configuration may refer to the sensor settings manager 520 (e.g., or the sensor settings manager 520 in electric communication with a processor). In some examples, determining the sensor setting configuration based on a first scene lighting condition, where the sensor setting configuration includes an exposure setting, a brightness setting, a focus setting, a white balance setting, or some combination thereof. In some examples, the sensor settings manager 520 may adjust the sensor setting configuration based on the initialized first sensor and a second scene lighting condition. In some examples, the sensor settings manager 520 may configure the first sensor with the stored sensor setting configuration after identification of the indication. The dual sensor manager 525 may determine to transition from the first sensor to a second sensor based on a capability of the first sensor, a capability of the second sensor, or both, where the determination to enable the first power mode for the first sensor is based on the determination to transition from the first sensor to the second sensor.

The display 535 may be any suitable display or screen allowing for user interaction and/or to present items (such as captured images and video) for viewing by a user. In some aspects, the display 535 may be a touch-sensitive display. In some cases, the display 535 may display images captured by sensor 530-a and sensor 530-b, where the displayed images that are captured by either sensor 530-a and sensor 530-b may depend on the configuration of sensor 530-a and sensor 530-b by the sensor configuration manager 540.

FIG. 6 shows a diagram of a system 600 including a device 605 that supports sensor LPM techniques in accordance with aspects of the present disclosure. The device 605 may be an example of or include the components of device 405, device 505, or a device as described herein. The device 605 may include a sensor configuration manager 610, an I/O controller 615, display 620, memory 630, and a processor 640. These components may be in electronic communication via one or more buses (e.g., bus 645).

The sensor configuration manager 610 may determine to enable a first power mode for a first sensor, transition the first sensor from a second power mode to the first power mode that is a lower power mode than the second power mode, transition the first sensor from the first power mode to the second power mode, store a sensor setting configuration in the first sensor based on determining to enable the first power mode for the first sensor, identify an indication of the sensor setting configuration stored in the first sensor based on the transitioning from the first power mode to the second power mode, and initialize the first sensor based on the indication and the stored sensor setting configuration.

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The memory 630 may include RAM and ROM. The memory 630 may store computer-readable, computer-executable code or software 635 including instructions that, when executed, cause the processor to perform various functions described herein. In some cases, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting sensor LPM techniques).

The software 635 may include instructions to implement aspects of the present disclosure, including instructions to support image processing. The software 635 may be stored in a non-transitory computer-readable medium such as system memory or other type of memory. In some cases, the software 635 may not be directly executable by the processor 640 but may cause a computer (e.g., when compiled and executed) to perform functions described herein.

The display 620 may be any suitable display or screen allowing for user interaction and/or to present items (such as captured images and video) for viewing by a user. In some aspects, the display 620 may be a touch-sensitive display. In some cases, the display 620 may display images captured by sensors, where the displayed images that are captured by sensors may depend on the configuration of active sensors by the sensor configuration manager 610.

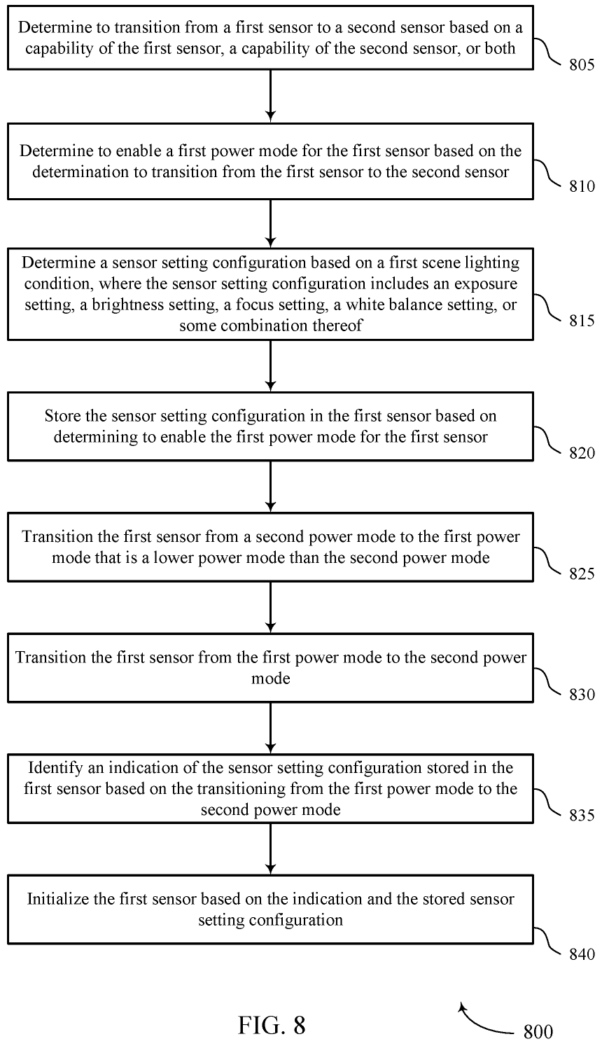

FIG. 7 shows a flowchart illustrating a method 700 that supports sensor LPM techniques in accordance with aspects of the present disclosure. The operations of method 700 may be implemented by a device or its components as described herein. For example, the operations of method 700 may be performed by a sensor configuration manager as described with reference to FIGS. 4 through 6. In some examples, a device may execute a set of instructions to control the functional elements of the device to perform the functions described below. Additionally or alternatively, a device may perform aspects of the functions described below using special-purpose hardware.

At 705, the device may determine to enable a first power mode (e.g., a LPM) for a first sensor. The operations of 705 may be performed according to the methods described herein. In some examples, aspects of the operations of 705 may be performed by an LPM manager as described with reference to FIGS. 4 through 6.

At 710, the device may store a sensor setting configuration in the first sensor based on determining to enable the first power mode for the first sensor. The operations of 710 may be performed according to the methods described herein. In some examples, aspects of the operations of 710 may be performed by a flash memory manager as described with reference to FIGS. 4 through 6.

At 715, the device may transition the first sensor from a second power mode to the first power mode that is a lower power mode than the second power mode. The operations of 715 may be performed according to the methods described herein. In some examples, aspects of the operations of 715 may be performed by an LPM manager as described with reference to FIGS. 4 through 6.

At 720, the device may transition the first sensor from the first power mode to the second power mode. The operations of 720 may be performed according to the methods described herein. In some examples, aspects of the operations of 720 may be performed by an LPM manager as described with reference to FIGS. 4 through 6.

At 725, the device may identify an indication of the sensor setting configuration stored in the first sensor based on the transitioning from the first power mode to the second power mode. The operations of 725 may be performed according to the methods described herein. In some examples, aspects of the operations of 725 may be performed by a flash memory manager as described with reference to FIGS. 4 through 6.

At 730, the device may initialize the first sensor based on the indication and the stored sensor setting configuration. The operations of 730 may be performed according to the methods described herein. In some examples, aspects of the operations of 730 may be performed by a sensor settings manager as described with reference to FIGS. 4 through 6.

FIG. 8 shows a flowchart illustrating a method 800 that supports sensor LPM techniques in accordance with aspects of the present disclosure. The operations of method 800 may be implemented by a device or its components as described herein. For example, the operations of method 800 may be performed by a sensor configuration manager as described with reference to FIGS. 4 through 6. In some examples, a device may execute a set of instructions to control the functional elements of the device to perform the functions described below. Additionally or alternatively, a device may perform aspects of the functions described below using special-purpose hardware.

At 805, the device may determine to transition from a first sensor to a second sensor based on a capability of the first sensor, a capability of the second sensor, or both. For example, a device may determine to transition between sensors for a variety of reasons including zoom capabilities of the different sensors, battery level conditions or power capacity of the different sensors, high definition capabilities of the different sensors, live feed capabilities of the different sensors, brightness setting capabilities of the different sensors, shutter speed capabilities of the different sensors, based on a certain sensor detecting motion or a target object using object recognition techniques, etc. The operations of 805 may be performed according to the methods described herein. In some examples, aspects of the operations of 805 may be performed by a dual sensor manager as described with reference to FIGS. 4 through 6.

At 810, the device may determine to enable a first power mode (e.g., a LPM) for the first sensor based on the determination to transition from the first sensor to the second sensor. The operations of 810 may be performed according to the methods described herein. In some examples, aspects of the operations of 810 may be performed by an LPM manager as described with reference to FIGS. 4 through 6.

At 815, the device may determine a sensor setting configuration based on a first scene lighting condition (e.g., based on images captured by the sensor before the sensor transitioning to the LPM), where the sensor setting configuration includes an exposure setting, a brightness setting, a focus setting, a white balance setting, or some combination thereof. The operations of 815 may be performed according to the methods described herein. In some examples, aspects of the operations of 815 may be performed by a sensor settings manager as described with reference to FIGS. 4 through 6.

At 820, the device may store a sensor setting configuration in the first sensor (e.g., in flash memory of the first sensor) based on determining to enable the first power mode for the first sensor. The operations of 820 may be performed according to the methods described herein. In some examples, aspects of the operations of 820 may be performed by a flash memory manager as described with reference to FIGS. 4 through 6.

At 825, the device may transition the first sensor from a second power mode to the first power mode that is a lower power mode than the second power mode. The operations of 825 may be performed according to the methods described herein. In some examples, aspects of the operations of 825 may be performed by an LPM manager as described with reference to FIGS. 4 through 6.

At 830, the device may transition the first sensor from the first power mode to the second power mode. The operations of 830 may be performed according to the methods described herein. In some examples, aspects of the operations of 830 may be performed by an LPM manager as described with reference to FIGS. 4 through 6.

At 835, the device may identify an indication of the sensor setting configuration stored in the first sensor based on the transitioning from the first power mode to the second power mode. The operations of 835 may be performed according to the methods described herein. In some examples, aspects of the operations of 835 may be performed by a flash memory manager as described with reference to FIGS. 4 through 6.

At 840, the device may initialize the first sensor based on the indication and the stored sensor setting configuration. The operations of 840 may be performed according to the methods described herein. In some examples, aspects of the operations of 840 may be performed by a sensor settings manager as described with reference to FIGS. 4 through 6.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for image processing at a device, comprising:
determining to enable a first power mode for a first sensor;
storing a sensor setting configuration in the first sensor based at least in part on determining to enable the first power mode for the first sensor, wherein the sensor setting configuration comprises an exposure setting, or a brightness setting, or a focus setting, or a white balance setting, or some combination thereof;
transitioning the first sensor from a second power mode to the first power mode that is a lower power mode than the second power mode;
transitioning the first sensor from the first power mode to the second power mode;
identifying an indication of the sensor setting configuration stored in the first sensor based at least in part on the transitioning from the first power mode to the second power mode; and
initializing the first sensor based at least in part on the indication and the stored sensor setting configuration.

2. The method of claim 1, further comprising:
determining to transition from the first sensor to a second sensor based at least in part on a capability of the first sensor, a capability of the second sensor, or both, wherein the determination to enable the first power mode for the first sensor is based at least in part on the determination to transition from the first sensor to the second sensor.

3. The method of claim 1, further comprising:
determining the sensor setting configuration based at least in part on a first scene lighting condition.

4. The method of claim 3, further comprising:
adjusting the sensor setting configuration based at least in part on the initialized first sensor and a second scene lighting condition.

5. The method of claim 1, further comprising:
setting a low power mode register command based at least in part on storing the sensor setting configuration, wherein the indication of the sensor setting configuration is identified based at least in part on the set low power mode register command.

6. The method of claim 1, wherein initializing the first sensor comprises:
configuring the first sensor with the stored sensor setting configuration after identification of the indication.

7. The method of claim 1, wherein transitioning the first sensor from the second power mode to the first power mode comprises:
transitioning the first sensor to a standby state, transitioning the first sensor to activate a reduced set of powered circuitry, powering off the first sensor, or some combination thereof, wherein the sensor setting configuration is stored in the first sensor before transitioning the first sensor from the second power mode to the first power mode.

8. The method of claim 1, wherein storing the sensor setting configuration in the first sensor comprises:
storing, by a driver of the first sensor, the sensor setting configuration in flash memory of the first sensor.

9. The method of claim 1, wherein:
determining to enable the first power mode for the first sensor is based at least in part on a low power mode register command received from a controller.

10. The method of claim 9, wherein:
storing the sensor setting configuration is based at least in part on the low power mode register command.

11. An apparatus for image processing at a device, comprising:
a processor,
memory coupled with the processor; and
instructions stored in the memory and executable by the processor to cause the apparatus to:
determine to enable a first power mode for a first sensor;
store a sensor setting configuration in the first sensor based at least in part on determining to enable the first power mode for the first sensor, wherein the sensor setting configuration comprises an exposure setting, or a brightness setting, or a focus setting, or a white balance setting, or some combination thereof;
transition the first sensor from a second power mode to the first power mode that is a lower power mode than the second power mode;
transition the first sensor from the first power mode to the second power mode;
identify an indication of the sensor setting configuration stored in the first sensor based at least in part on the transitioning from the first power mode to the second power mode; and
initialize the first sensor based at least in part on the indication and the stored sensor setting configuration.

12. The apparatus of claim 11, wherein the instructions are further executable by the processor to cause the apparatus to:
determine to transition from the first sensor to a second sensor based at least in part on a capability of the first sensor, a capability of the second sensor, or both, wherein the determination to enable the first power mode for the first sensor is based at least in part on the determination to transition from the first sensor to the second sensor.

13. The apparatus of claim 11, wherein the instructions are further executable by the processor to cause the apparatus to:
determine the sensor setting configuration based at least in part on a first scene lighting condition.

14. The apparatus of claim 13, wherein the instructions are further executable by the processor to cause the apparatus to:
adjust the sensor setting configuration based at least in part on the initialized first sensor and a second scene lighting condition.

15. The apparatus of claim 11, wherein the instructions are further executable by the processor to cause the apparatus to:
set a low power mode register command based at least in part on storing the sensor setting configuration, wherein the indication of the sensor setting configuration is identified based at least in part on the set low power mode register command.

16. The apparatus of claim 11, wherein the instructions to initialize the first sensor are executable by the processor to cause the apparatus to:
configure the first sensor with the stored sensor setting configuration after identification of the indication.

17. The apparatus of claim 11, wherein the instructions to transition the first sensor from the second power mode to the first power mode are executable by the processor to cause the apparatus to:
transition the first sensor to a standby state, transitioning the first sensor to activate a reduced set of powered circuitry, powering off the first sensor, or some combination thereof, wherein the sensor setting configuration is stored in the first sensor before transitioning the first sensor from the second power mode to the first power mode.

18. The apparatus of claim 11, wherein the instructions to store the sensor setting configuration in the first sensor are executable by the processor to cause the apparatus to:
store, by a driver of the first sensor, the sensor setting configuration in flash memory of the first sensor.

19. The apparatus of claim 11, wherein determining to enable the first power mode for the first sensor is based at least in part on a low power mode register command received from a controller.

20. An apparatus for image processing at a device, comprising:
means for determining to enable a first power mode for a first sensor;
means for storing a sensor setting configuration in the first sensor based at least in part on determining to enable the first power mode for the first sensor, wherein the sensor setting configuration comprises an exposure setting, or a brightness setting, or a focus setting, or a white balance setting, or some combination thereof;
means for transitioning the first sensor from a second power mode to the first power mode that is a lower power mode than the second power mode;
means for transitioning the first sensor from the first power mode to the second power mode;
means for identifying an indication of the sensor setting configuration stored in the first sensor based at least in part on the transitioning from the first power mode to the second power mode; and
means for initializing the first sensor based at least in part on the indication and the stored sensor setting configuration.
